(19) United States
(12) Patent Application Publication
(10) Pub. No.: US 2022/0395712 A1
(43) Pub. Date: Dec. 15, 2022

(54) FIRESTOP COLLAR FOR PROVIDING WATER AND GAS SEALING POST-FIRE EXPOSURE

(71) Applicant: Specified Technologies Inc., Somerville, NJ (US)

(72) Inventors: Julio Lopes, Melbourne, FL (US); Peter Schmitt, Morristown, NJ (US); DJ Cianfaglione, Bridgewater, NJ (US)

(21) Appl. No.: 17/785,215

(22) PCT Filed: Jul. 30, 2021
(86) PCT No.: PCT/US2021/043877

§ 371 Date: Jun. 14, 2022

Related U.S. Application Data
(60) Provisional application No. 63/058,590, filed on Jul. 30, 2020.

(51) Int. Cl. A62C 2/06; F16L 5/04

(52) U.S. Cl. CPC A62C 2/065; F16L 5/04

(57) ABSTRACT

A firestop assembly configured for sealing about a pipe extending through a passage in a building structure division with a sealing element sealing the passage about the pipe. The firestop assembly includes a tube configured to be positioned about the pipe and secured relative to the building structure division. An intumescent material is positioned within the tube. A heat reduction insulation is supported by the tube such that the heat reduction insulation extends about the sealing element and minimizes heating of the sealing element.

This application is the national phase of Appln. No. PCT/US21/43877, filed Jul. 30, 2021, which claims the benefit of U.S. Prov. Appln. No. 63/058,590, filed on Jul. 30, 2020, the contents of each of which are incorporated herein by reference.

### FIELD

This disclosure relates to firestop collars. More particularly, the disclosure relates to firestop collars which provide a water and gas sealing post-fire exposure.

### BACKGROUND

It is commonplace in building structures for the need to pass cables, conduits and the like through construction barriers such as walls, floors and ceilings. However, the presence of an opening through such barriers raises a potential hazard in that a fire can use those opening to pass through the construction barrier, which of itself is an effective fire barrier, and the fire can then spread to adjoining areas of the building. As such, firestop systems are normally located within the openings that are designed to prevent the passage of fire through those openings.

Additional considerations and requirements occur when the building structure is subject to potential high pressure, for example, in marine applications. It is common to test firestop systems in marine applications for water and gas tightness. This is typically a pressure test where the seal is subjected to a certain head pressure for a period prior to a fire test. The idea was to evaluate water-tightness of the seals where breeches occur in bulkheads and decks that could cause compartment flooding and stability issues onboard large vessels.

In June 2017, SOLAS (Safety of Life At Sea) Regulations were amended to require pressure testing to be conducted after fire exposure. The intent behind the new criteria was to evaluate if after fire exposure, the seals could still maintain the integrity of the water-tight compartment.

After modification of SOLAS regulations, the market responded by using longer sleeves that would push the firestop sealing systems further away from the heat source. However, using longer lengths of sleeves can be challenging because it adds significant weight and, in some cases, there is insufficient space to allow the sleeves to be installed as detailed to achieve performance. Traditional watertight collars do not work for pressure-after-fire because the seals degrade from the intense heat of the fire exposure, therefore, the only way to protect them is to keep them away from the heat source.

### SUMMARY

In at least one embodiment, the present disclosure provides a firestop assembly configured for sealing about a pipe extending through a passage in a building structure division with a sealing element sealing the passage about the pipe. The firestop assembly includes a tube configured to be positioned about the pipe and secured relative to the building structure division. An intumescent material is positioned within the tube. A heat reduction insulation is supported by the tube such that the heat reduction insulation extends about the sealing element and minimizes heating of the sealing element.

In at least one embodiment, the heat reduction insulation is an endothermic material configured to release chemically bound water.

In at least one embodiment, the heat reduction insulation is in the form of a panel configured to positioned between the tube and the division. Furthermore, the heat reduction insulation may additionally be in the form of a sleeve positioned between the tube.

In at least one embodiment, the heat reduction insulation is in the form of a sleeve positioned between the tube.

### BRIEF DESCRIPTION OF THE DRAWINGS

The accompanying drawings, which are incorporated herein and constitute part of this specification, illustrate the presently preferred embodiments of the disclosure, and, together with the general description given above and the detailed description given below, serve to explain the features of the invention. In the drawings:

FIG. 1 is a perspective view of a firestop assembly in accordance with an embodiment of the disclosure positioned about a pipe extending through a bulkhead wall.

FIG. 2 is a perspective cross-sectional view of the firestop assembly of FIG. 1.

FIG. 3 is an elevational cross-sectional view of the firestop assembly of FIG. 1.

FIGS. 4-7 are perspective views and FIG. 8 is an elevation view illustrating a sequential installation of the firestop assembly of FIG. 1.

FIG. 9 is a perspective view of a firestop assembly in accordance with another embodiment of the disclosure positioned about a pipe extending through a bulkhead wall.

FIG. 10 is a perspective cross-sectional view of the firestop assembly of FIG. 9.

FIG. 11 is an elevational cross-sectional view of the firestop assembly of FIG. 9.

FIGS. 12-16 are perspective views and FIG. 17 is an elevation view illustrating a sequential installation of the firestop assembly of FIG. 9.

### DETAILED DESCRIPTION

In the drawings, like numerals indicate like elements throughout. Certain terminology is used herein for convenience only and is not to be taken as a limitation on the present disclosure. The following describes preferred embodiments of the present disclosure. However, it should be understood, based on this disclosure, that the invention is not limited by the preferred embodiments described herein.

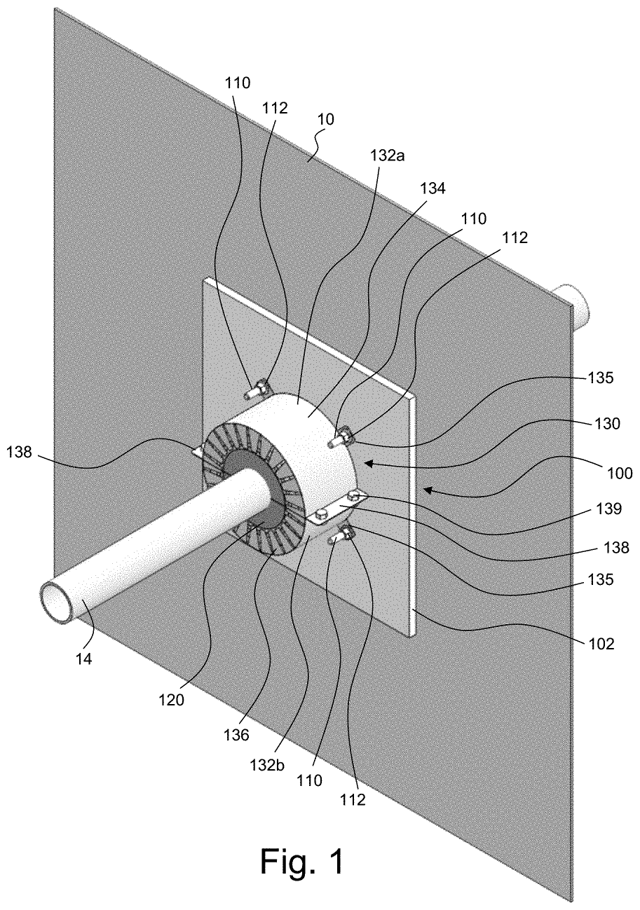

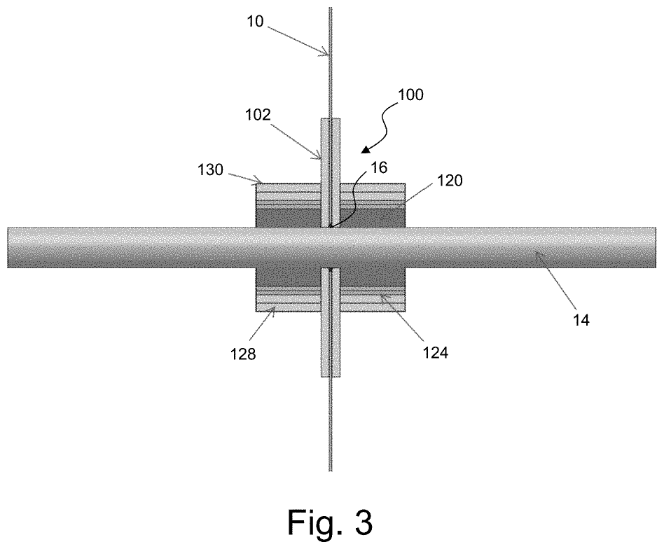

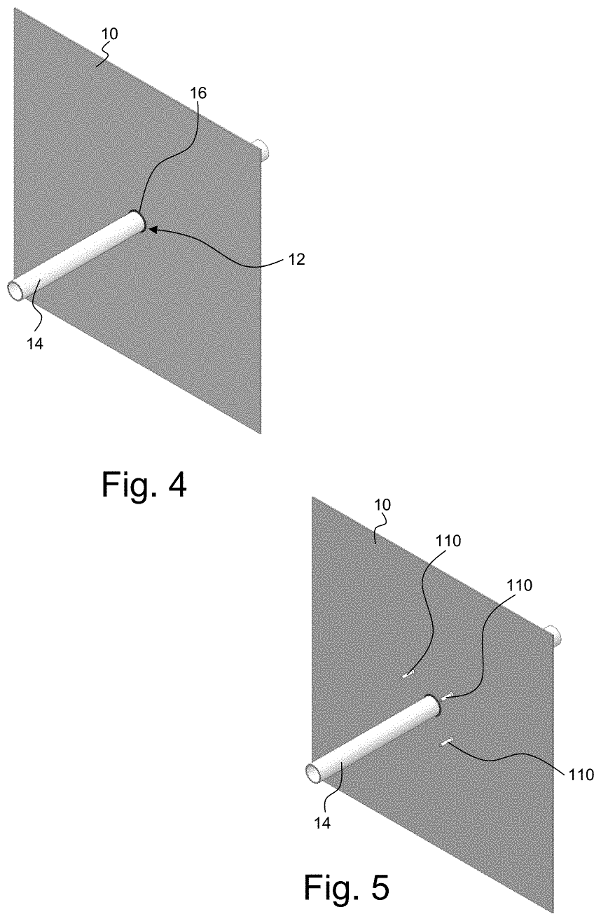

Referring to FIGS. 1-8, an illustrative embodiment of a firestop assembly 100 in accordance with an embodiment of the disclosure will be described. The firestop assembly 100 is configured to be secured about a pipe 14 or the like extending through a passage 12 in a division 10, e.g. wall, deck or the like of a structure subject to pressure, for example, a ship bulkhead (see FIG. 4). A sealing element 16 is positioned about the pipe 14 and provides a water-tight seal of the passage 12. An illustrative sealant is MFS Firestop Sealant available from Specified Technologies Inc., Somerville, N.J. This illustrative sealant is an advanced hybrid polymer sealant that cures in the presence of atmospheric moisture and is designed for fire-rated divisions. While a specific sealant is described, other sealants which provide a desired level of sealing may be utilized. Additionally, while a sealant is illustrated, a rubber grommet or the like which is sized to fit the outer diameter of the pipe 14 may be utilized. The firestop assembly 100 is configured to provide the desired fire protection to the pipe 14, but is also configured to maintain the sealing element 16 such that a water-tight seal of the passage 12 is maintained even after fire. Preferably a firestop assembly 100 is positioned on each side of the division 10, as shown in FIGS. 3 and 8. The firestop assemblies 100 have the same configuration but could have different configurations.

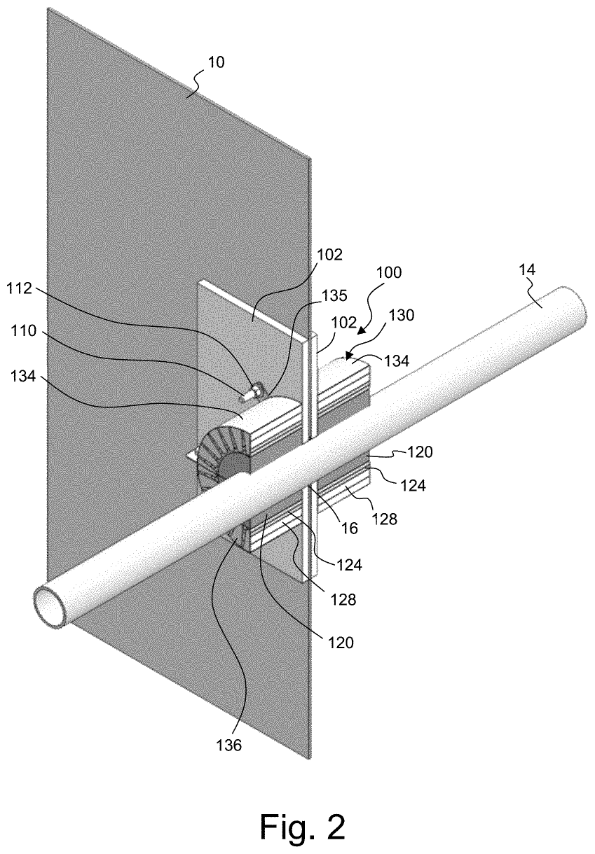

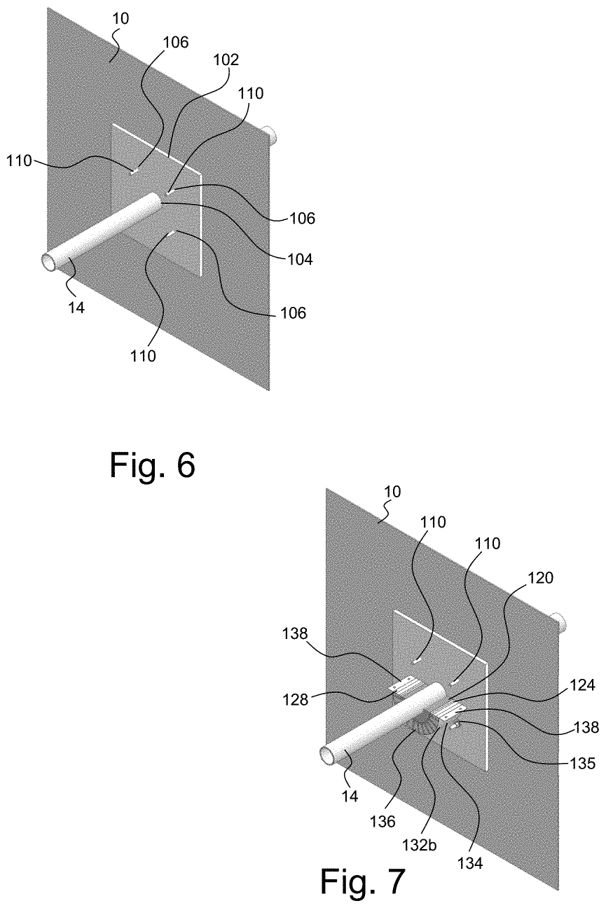

Referring to FIGS. 1-3, the firestop assembly 100 generally comprises a heat reduction insulation panel 102 and a collar assembly 130. In the illustrated embodiment, the heat reduction panel 102 is configured to be positioned along the division 10 with the pipe 14 extending through an opening 104 in the panel 102. As illustrated in FIG. 2, the opening 104 inner diameter is preferably equal to the pipe 14 outer diameter such that the panel 102 is tight about the pipe 14 and overlies the sealant element 16. The sealant element 16 is effectively sandwiched between the two panels 102. With reference to FIG. 6, the panel 102 may have a plurality of mounting holes 106 configured to align with mounting posts 110 extending from the division 10 to mount and secure the panel 102 to the division 10, however, other mounting configurations may be utilized.

The heat reduction insulation panel 102 is manufactured from an insulation material configured to reduce transmission of heat and/or provide a cooling effect. An illustrative material is E-Wrap™ endothermic wrap available from Specified Technologies Inc., Somerville, N.J. The E-Wrap™ endothermic wrap is configured to release chemically bound water to have a cooling effect. While an insulation which releases a cooling agent is described, the invention is not limited to that and other insulation materials may be utilized.

The collar assembly 130 includes a tube 134 enclosing intumescent material 124 and additional heat reduction insulation 128. The tube 134 is manufactured from a fire resistant, generally rigid structure, for example, steel, another metal or the like. In the illustrated embodiment, an optional resilient foam insert 120 is positioned between the intumescent material 124 and the pipe 14 to accommodate variations in outer diameter and to allow the collar assembly 130 to be adjustable or range taking. The additional heat reduction insulation 128 may be manufactured from a material similar to that described above with respect to the panel 102. The intumescent material 124 is designed to expand rapidly responsive to fire and heat for the purpose of sealing off the passage 12. The intumescent material 124 preferably includes a foam component chosen of one of various polymers such as polyurethane or silicone or any other polymer which has the capability of forming a soft resilient foam. The intumescent component of the foam may include expandable graphite, sodium silicate or any other commonly used expansion ingredient which is compatible for use with the basic foam carrier construction.

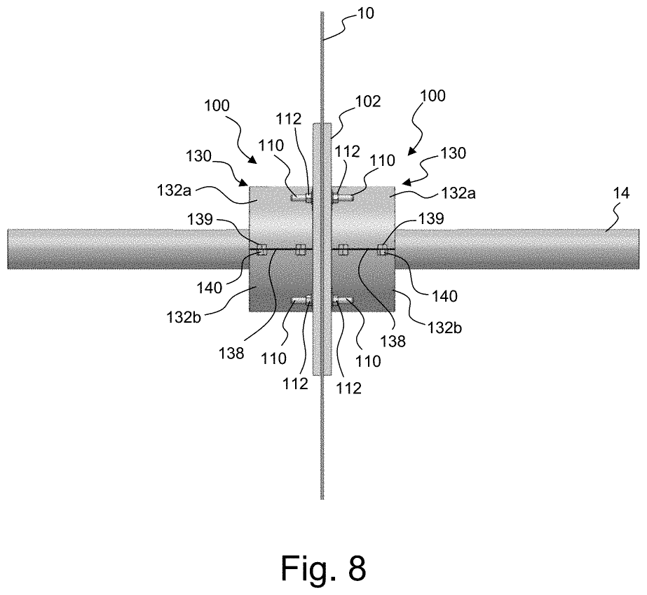

As illustrated in FIGS. 1 and 7, the collar assembly 130 may be provided in two halves 132a, 132b which are configured to be positioned and secured about the pipe 14. Each half 132a, 132b includes 180° of tube 134, foam insert 120 (if included), intumescent material 124 and additional heat reduction insulation 128. A flange 138 extends radially outward from each portion of the tube 134 and bolts 139 and nuts 140 secure the two halves 132a, 132b together once they are positioned about the pipe 14. While the illustrated collar assembly 130 includes interconnected halves, it may be formed as a unitary structure slid over the pipe or any other unitary or multi-component construction. A plurality of mounting tabs 135 extend from one end of the tube 134 and are configured to be positioned on the mounting posts 110 and secured by nuts 112 or the like. While tabs 135 and posts 110 are described, other configurations for securing the collar assembly 130 to the division 10 may also be utilized. Radially inward extending tabs 136 extend from the opposite end of the tube 134 to help retain the intumescent material 124 and insulation 128 within the tube 134.

When the firestop assembly 100 is exposed to fire and/or excessive heat, the intumescent material 124 expands to collapse the plastic pipe 14 and squeeze it off. The insulation materials 102, 128 keep the bulkhead or deck passage 12 well insulated throughout the fire exposure, but most importantly, keeps the seal element 16 within the bulkhead or deck passage 12 from being distressed due to heat. By insulating the seal element 16 at the division interface, the pipe 14 remains independently sealed even after exposure to fire. It is not necessary to install the sealing systems at the ends of long sleeves which project a significant distance from the bulkhead, as required in current systems. The firestop assembly 100 does not require an extended sleeve which saves on space and no added weight. Additionally, the firestop assembly 100 does not require continuous welds to the division which saves on installation time and labor.

Having generally described the components of the firestop assembly 100, an illustrative method of installation thereof will be described with reference to FIGS. 4-8. As a first step, sealing element 16 is utilized to seal around the circumference of pipe 14 at interface of bulkhead or deck passage 12, as shown in FIG. 4. Turning to FIG. 5, the mounting posts 110 are welded to the division 10 for attachment of insulation panel 102. As explained above, other means of securing the insulation panel 102 may be employed.

Moving to FIG. 6, the insulation panel 102 is positioned with the pipe 14 passing through the opening 104 and the posts 110 passing through the openings 106. As explained above, the panel 102 preferably overlies the sealing element 16. One half 132b of the firestop collar 130 is positioned against the panel 102 with the mounting posts 110 extending through the tabs 135. Nuts 112 may be loosely secured on the posts 110 to maintain the collar half 132b in position. As shown in FIG. 7, the foam insert 120, intumescent material 124 and additional heat reduction insulation 128 wrap about one half of the pipe 14. The second half 132a of the collar assembly 130 is positioned opposite the first half 132b and secured thereto via fasteners 139 and nuts 140 extending through the flanges 138 as shown in FIG. 8. The pipe 14 is surrounded by the foam insert 120, intumescent material 124 and additional heat reduction insulation 128. The nuts 112 may thereafter be tighten to secure the collar assembly 130 against the panel 102 and division 10. The sealing element 16 is enclosed within and protected by the heat reduction insulation 102, 128. As explained above, when the firestop assembly 100 is exposed to fire and/or excessive heat, the intumescent material 124 expands to collapse the plastic pipe 14 and squeeze it off. The insulation materials 102, 128 keep the bulkhead or deck passage 12 well insulated throughout the fire exposure, but most importantly, keeps the seal element 16 within the bulkhead or deck passage 12 from being distressed due to heat.

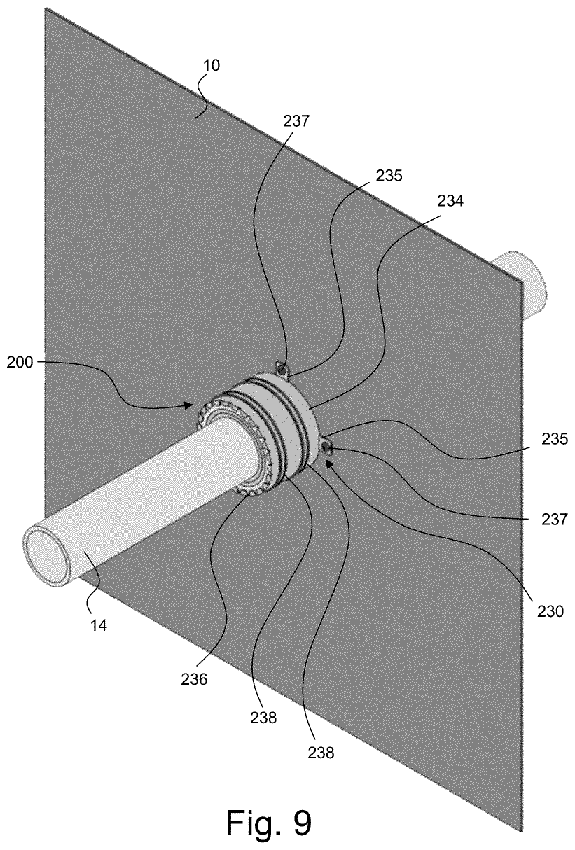

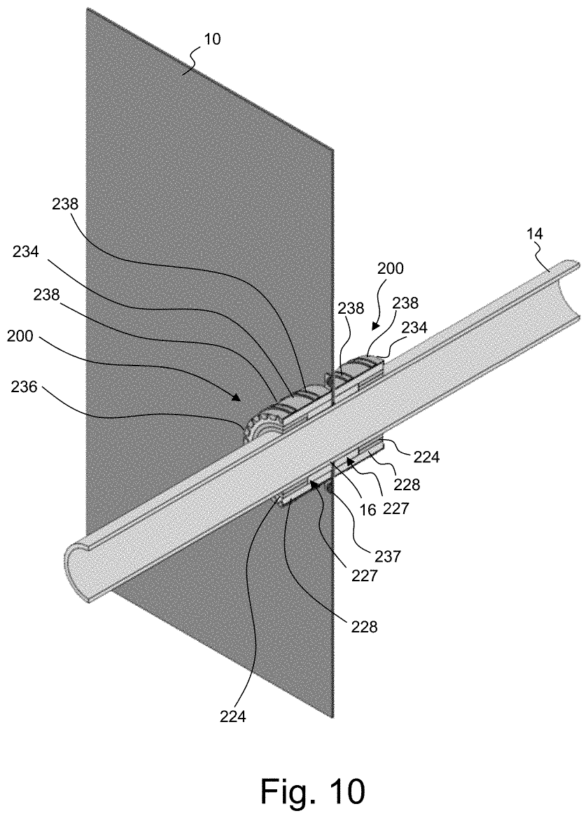

Referring to FIGS. 9-17, an illustrative embodiment of a firestop assembly 200 in accordance with another embodiment of the disclosure will be described. Similar to the previous embodiment, the firestop assembly 200 is configured to be secured about a pipe 14 or the like extending through a passage 12 in a division 10, e.g. wall, deck or the like of a structure subject to pressure, for example, a ship bulkhead. The firestop assembly 200 is configured to provide the desired fire protection to the pipe 14, but is also configured to maintain the sealing element 16 such that a water-tight seal of the passage 12 is maintained even after fire. Preferably a firestop assembly 200 is positioned on each side of the division 10, as shown in FIGS. 10, 11 and 17. The firestop assemblies 200 have the same configuration but could have different configurations.

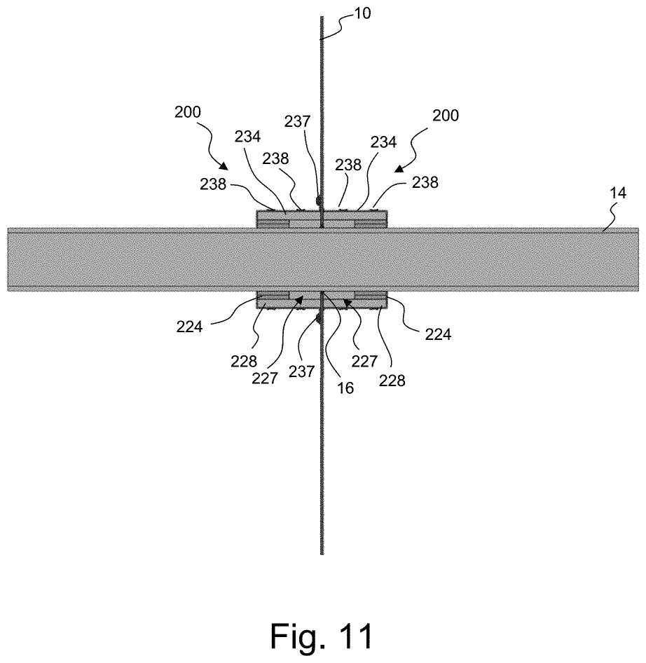

Referring to FIGS. 9-11, the firestop assembly 200 generally comprises a collar assembly 230 configured to be secured to the division 10 about the pipe 14. The collar assembly 230 includes a tube 234 enclosing intumescent material 224 and heat reduction insulation 228. The tube 234 is manufactured from a fire resistant, generally rigid structure, for example, steel, another metal or the like. The heat reduction insulation 228 may be manufactured from a material similar to that described above with respect to the panel 102 of the previous embodiment. The intumescent material 224 is designed to expand rapidly responsive to fire and heat for the purpose of sealing off the passage 12. The intumescent material 224 may be manufactured from material similar to that described above. Referring to FIGS. 10 and 11, the intumescent material 224 is preferably radially inward of the heat reduction insulation 228. An air gap 227 may be defined between the intumescent material 224 and the division 10 such that the insulation 228 may act to remove heat directly about the sealing element 16. Alternatively, the air gap 227 may contain additional heat reduction insulation.

In the present embodiment, the collar assembly 230 is provided as a unitary structure with the tube 234 extending 360° about the pipe 14. However, it is understood that the collar assembly 230 may be provided in multiple components similar to the structure described above with respect to the previous embodiment. Additionally, while not shown in the illustrated embodiment, an optional resilient foam insert may be positioned between the intumescent material 224 and the pipe 14 to accommodate variations in outer diameter and to allow the collar assembly 230 to be adjustable or range taking.

A plurality of mounting tabs 235 extend from one end of the tube 234 and are configured to be positioned against the division 10. Welds 237 or the like may be utilized to secure the tabs 235 to the division 10. Radially inward extending tabs 236 extend from the opposite end of the tube 234 to help retain the intumescent material 224 and insulation 228 within the tube 234.

When the firestop assembly 200 is exposed to fire and/or excessive heat, the intumescent material 224 expands to collapse the plastic pipe 14 and squeeze it off. The insulation material 228 keeps the bulkhead or deck passage 12 well insulated throughout the fire exposure, but most importantly, keeps the seal element 16 within the bulkhead or deck passage 12 from being distressed due to heat. By insulating the seal element 16 at the division interface, the pipe 14 remains independently sealed even after exposure to fire. It is not necessary to install the sealing systems at the ends of long sleeves which project a significant distance from the bulkhead, as required in current systems. The firestop assembly 200 does not require an extended sleeve which saves on space and no added weight. Additionally, the firestop assembly 200 does not require continuous welds to the division 10 which saves on installation time and labor.

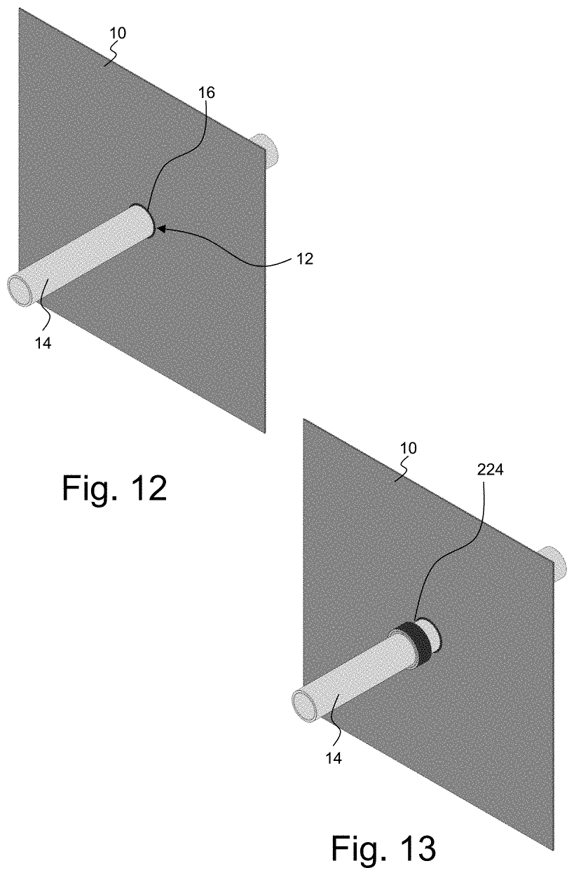

Having generally described the components of the firestop assembly 200, an illustrative method of installation thereof will be described with reference to FIGS. 12-17. As a first step, sealing element 16 is utilized to seal around the circumference of pipe 14 at interface of bulkhead or deck passage 12, as shown in FIG. 12. Turning to FIG. 13, a sleeve of intumescent material 224 is positioned about the pipe 14, preferably spaced from the division 10.

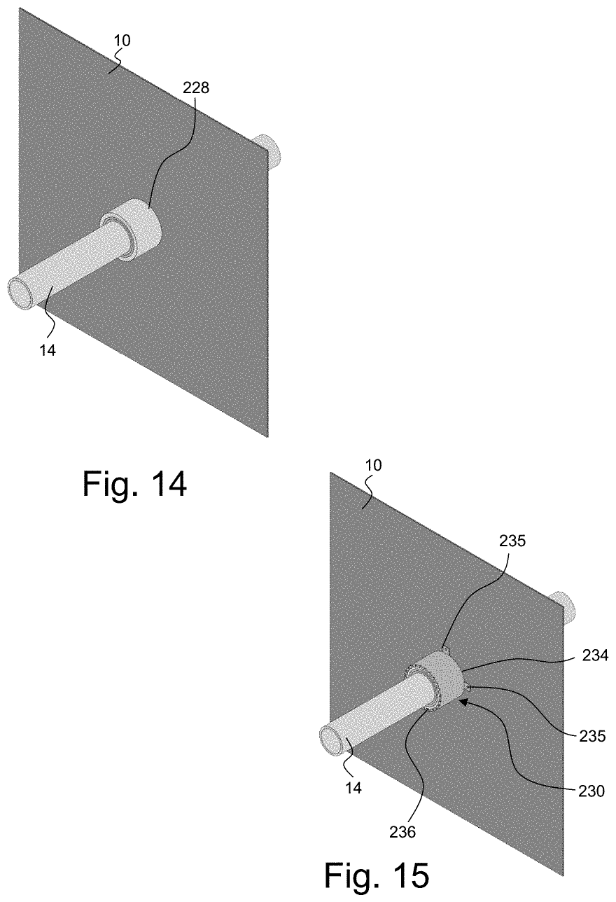

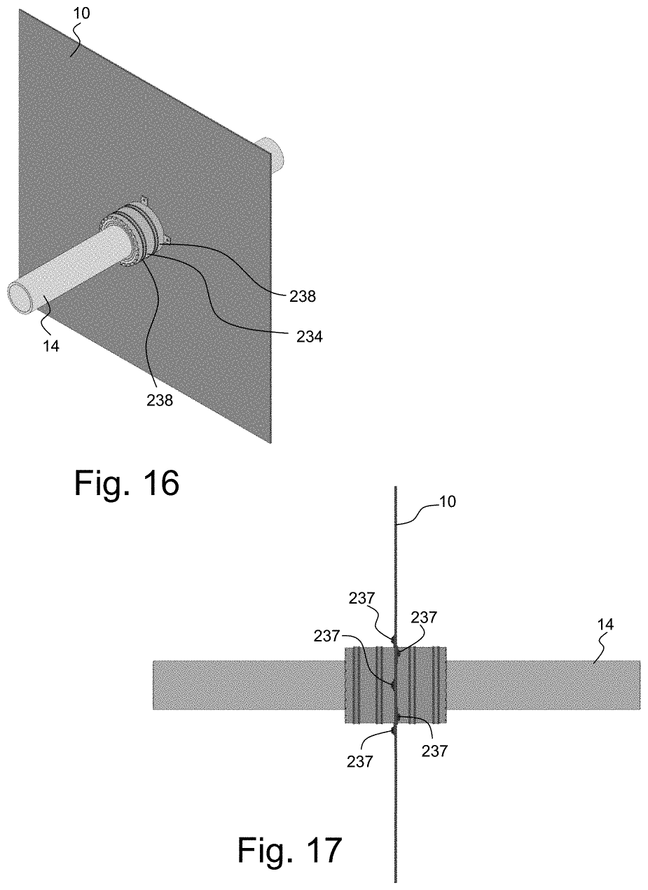

Moving to FIG. 14, a sleeve of the insulation 228 is positioned about the pipe 14, covering the intumescent material 224 and extending from the intumescent material 224 to the division 10. As shown in FIG. 15, the tube 234 is positioned about the pipe 14, extending around the insulation 228 and intumescent material 224. The mounting tabs 235 extend along the division 10 and the extending tabs 236 retain the materials 224, 228 within the tube 234. FIG. 16 illustrates steel straps 238 positioned and secured about the tube 234. The straps 238 help to secure the materials within the tube 234 and provide the tube 234 with further rigidity. With the tube 234 secured about the materials, the tube 234 is secured to the division 10 via welds 237 or the like at tabs 235, as shown in FIG. 17.

The sealing element 16 is enclosed within and protected by the heat reduction insulation 228. As explained above, when the firestop assembly 200 is exposed to fire and/or excessive heat, the intumescent material 224 expands to collapse the plastic pipe 14 and squeeze it off. The insulation material 228 keeps the bulkhead or deck passage 12 well insulated throughout the fire exposure, but most importantly, keeps the seal element 16 within the bulkhead or deck passage 12 from being distressed due to heat.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A firestop assembly configured for sealing about a pipe extending through a passage in a building structure division with a sealing element sealing the passage about the pipe, the firestop assembly comprising:
a tube configured to be positioned about the pipe and secured relative to the building structure division;
an intumescent material positioned within the tube;
a heat reduction insulation supported by the tube such that the heat reduction insulation extends about the sealing element and minimizes heating of the sealing element.

2. The firestop assembly of claim 1 wherein the heat reduction insulation is an endothermic material configured to release chemically bound water.

3. The firestop assembly of claim 1 wherein the heat reduction insulation is in the form of a panel configured to positioned between the tube and the building structure division.

4. The firestop assembly of claim 3 wherein the heat reduction insulation is additionally in the form of a sleeve positioned within the tube.

5. The firestop assembly of claim 1 wherein the heat reduction insulation is in the form of a sleeve positioned within the tube.

6. The firestop assembly of claim 5 wherein the sleeve is positioned within the tube spaced from the building structure division such that an air gap is formed between the sleeve and the sealing element.

7. The firestop assembly of claim 1 wherein the firestop assembly maintains water and gas tightness of the passage without being continuously welded to the building structure division.

8. The firestop assembly of claim 1 wherein the tube has a circumferentially continuous structure.

9. The firestop assembly of claim 1 wherein the tube includes interconnected portions which together define a circumferentially continuous structure.

10. The firestop assembly of claim 1 wherein the tube has a free end and tabs extend radially inward along the free end to retain materials positioned within the tube.

11. The firestop assembly of claim 1 wherein the tube has a connected end with a plurality of radially outward extending mounting tabs.

12. The firestop assembly of claim 1 wherein a resilient foam insert is positioned between the intumescent material and the tube.

13. A building structure assembly comprising:
a building structure division defining a through passage;
a pipe extending through the through passage;
a sealing element sealing the through passage about the pipe;
a first fire stop assembly according to claim 1 secured about the pipe on a first side of the building structure division; and
a second fire stop assembly according to claim 1 secured about the pipe on a second, opposite side of the building structure division.

14. The building structure assembly of claim 13 wherein the sealing element is insulated between the heat reduction insulation of the first and second fire stop assemblies.

15. The building structure assembly of claim 13 wherein the building structure is subject to pressure.

16. The building structure assembly of claim 15 wherein the building structure is a ship bulkhead.

17. The building structure assembly of claim 13 wherein the first and second fire stop assemblies have the same configuration.

18. The building structure assembly of claim 13 wherein the heat reduction insulation of each fire stop assembly is an endothermic material configured to release chemically bound water.

19. The building structure assembly of claim 13 wherein the heat reduction insulation of each of the first and second fire stop assemblies includes a sleeve positioned within the respective tube.

20. The building structure assembly of claim 19 wherein each sleeve is positioned within the respective tube spaced from the building structure division such that an air gap is formed between the sleeve and the sealing element.
